(19) United States
(12) Patent Application Publication
(10) Pub. No.: US 2026/0114580 A1
(43) Pub. Date: Apr. 30, 2026

(54) RAZOR RINSER DEVICE

(71) Applicant: The Clean Shave Co LLC, Philadelphia, PA (US)

(72) Inventor: Anderson Sumner Camp, Philadelphia, PA (US)

(73) Assignee: The Clean Shave Co LLC, Philadelphia, PA (US)

(21) Appl. No.: 19/005,607

(22) Filed: Dec. 30, 2024

Related U.S. Application Data
(60) Provisional application No. 63/616,656, filed on Dec. 31, 2023.

(51) Int. Cl. A45D 27/46; B08B 3/02; B08B 3/14

(52) U.S. Cl. CPC A45D 27/46; B08B 3/02; B08B 3/14; B08B 2203/0252; B08B 2203/0264; B08B 2203/027

(57) ABSTRACT

A self-contained razor rinser device for removing shaving debris from a razor is configured to interface with a surface of the razor and further configured to increase a first pressure of a rinsing fluid. At least one discharge section is configured to direct the rinsing fluid toward a blade of the razor.

### CROSS-REFERENCE TO RELATED APPLICATION

This application claims priority to U.S. Provisional Application No. 63/616,656, filed Dec. 31, 2023, the disclosure of which is incorporated by reference herein in its entirety.

### FIELD OF THE INVENTION

The present disclosure relates generally to systems and methods for removing shaving debris from a razor, more particularly, a self-contained razor rinser device configured to direct rinsing fluid toward the blade of the razor.

### BACKGROUND

A razor is a common device used for removing hair from skin. The razor is typically used in a shaving process known as wet shaving. Wet shaving incudes removing hair with the razor while the skin is wet with a shaving aid. The shaving aid, for example, can include water, lather, oil, or any other suitable product, and the shaving aids may be used alone or in any combination. Lather is typically created using a soap, a cream, or a gel. The razor is used to remove the hair and the shaving aid from the skin.

Shaving debris includes the hair and the shaving aid and must be periodically cleaned from the razor to prevent clogging of a blade, or blades. Conventional methods for cleaning the razor require a source of running water, an active drain, and may fail to sufficiently remove the shaving debris the razor. Failure can occur, for example, because the source of running water is insufficient to generate hydraulic agitation needed to sufficiently flush the razor. This can be true regardless of the frequency or duration that the razor is exposed to the source of running water. Failing to thoroughly clean the razor during use can reduce the razor's effectiveness to remove the hair and can cause discomfort to a user. Failing to thoroughly clean the razor between uses can reduce a life span of the blade or blades, thus necessitating premature and expensive replacements.

Water is a precious resource, and using a steady flow of water to rinse the razor is a wasteful endeavor. Wasting water is not a sustainable practice and is environmentally unfriendly. Moreover, running water may not be accessible in all locations or in all circumstances. For example, running water may not be available in temporary lodging arrangements such as tents used for camping or makeshift shelters used for certain outdoor activities. Even if running water is accessible, it may be desirable to conserve its use. For example, recreational vehicles (i.e. motor homes) and boats/ships commonly have fresh water supply tanks of a fixed volume. In situations involving a finite supply of water, it is advantageous to limit use to necessary applications. Additionally, in some areas of the world, sanitary running water is simply not available, is unreliable, or is cost-prohibitive for non-essential uses. Similar circumstances can also arise in the context of an ongoing emergency.

Traditional methods of cleaning the razor also require the user to clean a work area after the shaving process has concluded. For example, wash basins, or sinks, typically become soiled with residue from the shaving debris generated during the shaving process. Even with an active drain, the debris often remains present on the basin surface. Removing the shaving debris usually requires a subsequent rinsing procedure or a more thorough cleaning. The additional rinsing or cleaning step results in further waste of resources, possible expenditure, and/or inconvenience for the user. Additionally, it is possible that, over time, the shaving debris will accumulate in the drain. Accumulated shaving debris can cause a clog in the drain, requiring further attention to resolve. Again, this can lead to a further waste of resources, possible expenditure, and/or inconvenience for the user.

For at least these reasons, systems and methods for effectively removing shaving debris from the razor without the need for running water, a drain, or other fixtures are needed.

### SUMMARY

In one aspect of the present disclosure, a razor rinser device includes a basin configured to contain a rinsing fluid at a first pressure, a pump in fluid communication with the basin and configured to increase the pressure of the rinsing fluid to a second pressure, a contact surface configured to interface with a surface of a razor, and a discharge section in fluid communication with the pump and configured to direct the rinsing fluid toward a blade of the razor.

In another aspect of the present disclosure, the basin includes a receptacle configured to receive a handle of the razor and maintain the razor in a resting position.

In another aspect of the present disclosure the basin includes a recessed area configured to display information.

In another aspect of the present disclosure, the basin includes at least one pedestal configured to stabilize the basin.

In another aspect of the present disclosure, the basin includes an indexing element disposed on an interior proximal surface of the basin, the indexing element configured to retain a spring.

In another aspect of the present disclosure, the pump is disposed concentrically within the basin and the discharge section is arranged concentrically with the pump.

In another aspect of the present disclosure, the discharge section includes a spray manifold configured to accelerate the rinsing fluid.

In another aspect of the present disclosure, a contact surface is configured to stabilize the razor.

In another aspect of the present disclosure, the contact surface is configured to form a seal with the surface of the razor and maintain a fluid path between the discharge section and at the blade of the razor.

In another aspect of the present disclosure, the pump is a positive displacement pump.

In another aspect of the present disclosure, the pump is configured as a piston pump. The piston pump includes a housing in fluid communication with the basin and a movable piston disposed within the housing and configured to define a fluid chamber. The piston pump defines a fluid outlet in fluid communication with the fluid chamber.

In another aspect of the present disclosure, the housing is configured to mount to the basin. The housing includes a proximal surface configured to define an apex of the housing, a fluid inlet configured to direct the rinsing fluid into the housing, and an inlet valve that is in fluid communication with the fluid inlet.

In another aspect of the present disclosure, the proximal surface includes a drain configured to allow the rinsing fluid to flow to the basin.

In another aspect of the present disclosure, the proximal surface includes a retaining surface configured to retain the movable piston within the housing.

In another aspect of the present disclosure the at least one fluid inlet includes an embossment configured to define a filter mount.

In another aspect of the present disclosure, the embossment is configured to orient the filter mount at an angle other than zero degrees with respect to a vertical axis.

In another aspect of the present disclosure, the filter mount is configured to receive at an inlet filter.

In another aspect of the present disclosure, the filter mount is configured to facilitate removal of the inlet filter therefrom.

In another aspect of the present disclosure, the inlet valve is configured to permit the rinsing fluid to flow in only one direction.

In another aspect of the present disclosure, the inlet valve is an umbrella valve.

In another aspect of the present disclosure, the movable piston includes an outlet valve in fluid communication with the fluid outlet, and a sealing device configured to form a seal between a periphery of the movable piston and an inner surface of the housing.

In another aspect of the present disclosure, the at least one outlet valve is configured to permit the rinsing fluid to flow in only one direction.

In another aspect of the present disclosure, the outlet valve is an umbrella valve.

In another aspect of the present disclosure, the movable piston further comprises a transverse member configured to fit within the housing. The transverse member includes an outer edge configured to define the periphery of the movable piston, a proximal surface, and a distal surface.

In another aspect of the present disclosure, the transverse member further comprises a guide. The guide includes a distal surface configured to interface with an inner mating surface of the basin and an outer surface configured to interface with the inner surface of the housing.

In another aspect of the present disclosure, the distal surface of the guide extends away from the distal surface of the transverse member.

In another aspect of the present disclosure, the transverse member further comprises an indexing element disposed on the distal surface of the transverse member and configured to retain a spring.

In another aspect of the present disclosure, the fluid chamber is a first fluid chamber. The transverse member further includes a wall extending proximally from the proximal surface of the transverse member and configured to an additional fluid chamber in fluid communication with the fluid outlet.

In another aspect of the present disclosure, the wall is offset inwardly from the edge of the transverse member and configured to define a ledge.

In another aspect of the present disclosure, the wall defines a seal notch configured to interface with a protrusion on the sealing device.

In another aspect of the present disclosure, the fluid outlet comprises a spray manifold in fluid communication with the additional fluid chamber, wherein the spray manifold is configured to accelerate the rinsing fluid.

In another aspect of the present disclosure, a contact surface is configured to interface with at least one surface of the razor, wherein the contact surface is configured to form a seal with the surface of the razor and maintain a fluid path between the spray manifold and the blade of the razor.

In another aspect of the present disclosure, a volume of the fluid chamber is variable.

In another aspect of the present disclosure, a volume of the additional chamber is constant.

In another aspect of the present disclosure, the movable piston is configured to travel axially from a first position to a second position.

In another aspect of the present disclosure, the first position corresponds to a minimum volume of the at least one fluid chamber and the second position corresponds to a maximum volume of the at least one fluid chamber.

In another aspect of the present disclosure, the piston pump includes a spring configured to bias the movable piston toward the first position.

In another aspect of the present disclosure, the spring is positioned between an interior proximal surface of the basin and a distal surface of the movable piston.

In another aspect of the present disclosure, the spring is a helical compression spring.

In another aspect of the present disclosure, the movable piston is configured to increase the pressure of the rinsing fluid from the first pressure as the movable piston moves from the first position to the second position.

In another aspect of the present disclosure the first pressure is ambient pressure, and the second pressure is sufficient to open the outlet valve.

In another aspect of the present disclosure the rinsing fluid flows from outlet valve after reaching the second pressure.

In another aspect of the present disclosure, the movable piston is configured to decrease a pressure of the rinsing fluid remaining in the fluid chamber to a suction pressure as the movable piston travels from the second position to the first position.

In another aspect of the present disclosure, the suction pressure is sufficient to open the inlet valve.

In another aspect of the present disclosure, the rinsing fluid flows through the fluid inlet after reaching the suction pressure.

In another aspect of the present disclosure, the sealing device is a triple seal gasket configured to reduce friction between the periphery of the movable piston and an inner surface of the housing.

In another aspect of the present disclosure a razor rinser system includes the above the razor rinser device, a rinsing fluid, and a razor configured for shaving hair.

In another aspect of the present disclosure, the razor is a cartridge-type razor.

In another aspect of the present disclosure, the razor is a disposable razor.

In another aspect of the present disclosure, the razor is a safety razor.

In another aspect of the present disclosure, the rinsing fluid is water.

In another aspect of the present disclosure, the rinsing fluid is a mixture of water and a cleaning agent.

In another aspect of the present disclosure, a method for cleaning a razor includes preparing a razor rinser device. The razor rinser device including a basin configured to contain a rinsing fluid at a first pressure, a pump in fluid communication with the basin and configured to increase the pressure of the rinsing fluid to a second pressure, a contact surface configured to interface with a surface of a razor, and a discharge section in fluid communication with the pump and configured to direct the rinsing fluid toward at least one blade of the razor. The method also includes shaving hair with a razor and rinsing shaving debris from the razor using the razor rinsing device.

In another aspect of the present disclosure, the preparing the razor rinser device step includes filling the basin with a sufficient amount of the rinsing fluid.

In another aspect of the present disclosure, the method further includes priming the pump.

In another aspect of the present disclosure the method further includes repeating the shaving and rinsing steps until a shaving process is complete.

In another aspect of the present disclosure, the method includes emptying the basin.

In another aspect of the present disclosure, the method further includes removing an inlet filter from a filter mount.

In another aspect of the present disclosure, the method further includes removing shaving debris from the inlet filter In another aspect of the present disclosure, the method further includes installing at an filter within a filter mount.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a top-front perspective view of an embodiment of a razor rinser system according to the present invention, depicting a cartridge type razor in a first rinsing position.

FIG. 2 is a top view of the razor rinser system shown in FIG. 1.

FIG. 3 is a top-rear perspective view of the razor rinser system shown in FIGS. 1-2, depicting the cartridge-type razor in a resting position.

FIG. 4 is an exploded top-left perspective view of components of the razor rinser device shown in FIGS. 1-3.

FIG. 5 is an exploded front view of components of the razor rinser device shown in FIGS. 1-4.

FIG. 6 is a bottom-left perspective view of the razor rinser shown in FIGS. 1-5.

FIG. 7 is a top view of the razor rinser device shown in FIGS. 1-6.

FIG. 8 is a right-side view of the razor rinser device shown in FIGS. 1-7.

FIG. 9 is a cross-sectional view of the razor rinser device shown in FIGS. 1-8, taken through the line IX-IX of FIG. 8.

FIG. 10 is a front view of the razor rinser device shown in FIGS. 1-9.

FIG. 11 is a cross-sectional view of the razor rinser device shown in FIGS. 1-10, taken through the line XI-XI of FIG. 10.

### DETAILED DESCRIPTION

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

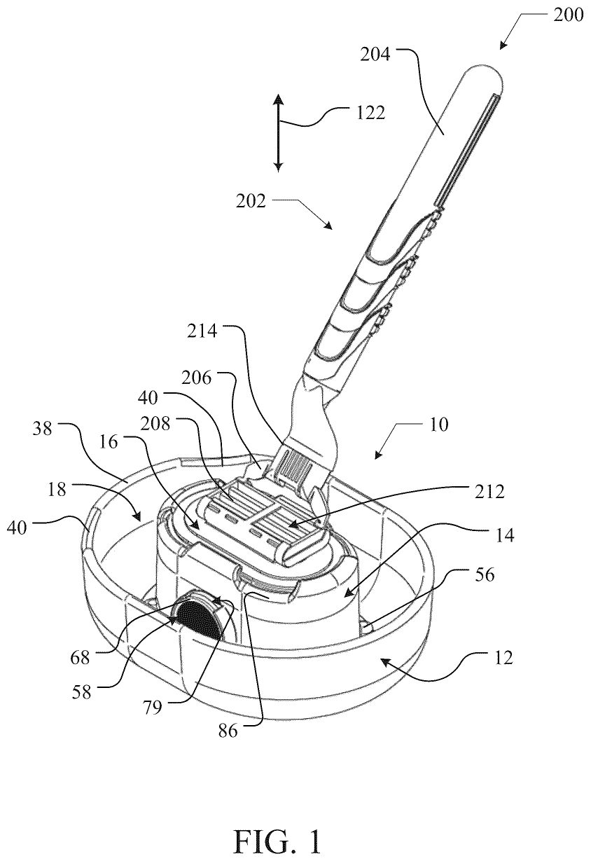

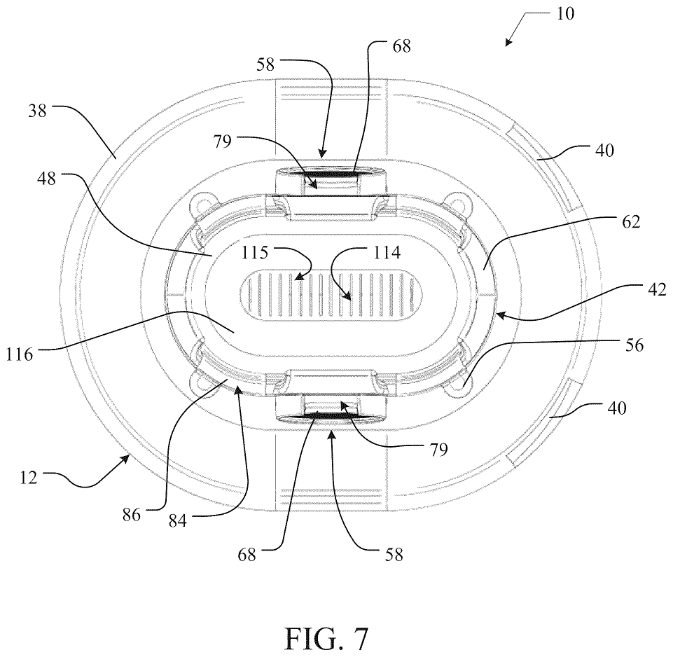

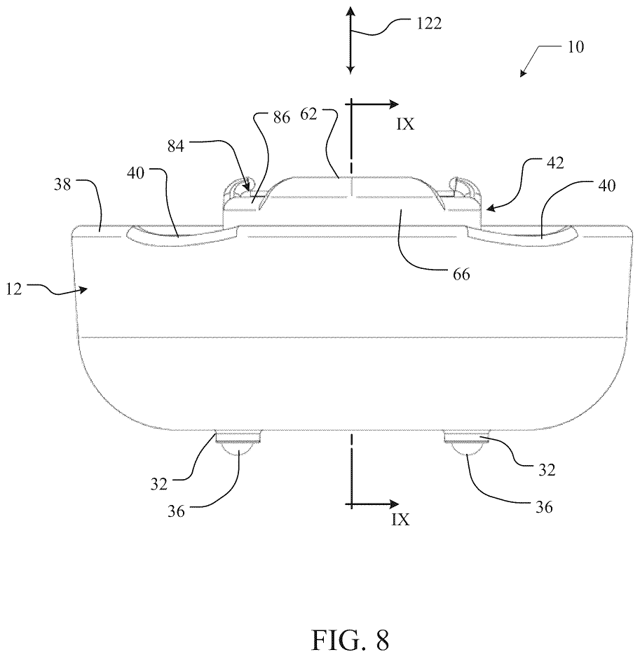

FIGS. 1-11 depict a razor rinser device 10 configured to clean shaving debris (not show) from a razor 202. The razor 202 is used in a shaving process, commonly known as wet shaving. Wet shaving incudes removing hair (not shown) from skin (not shown) with the razor 202 while the skin is wet with a shaving aid (not shown). The shaving aid, for example, can include water, a lather, an oil, or any other suitable product, and the shaving aid can be used alone or in any combination. The lather is typically created using a soap, a cream, or a gel. The razor 202 is used to remove the hair and the shaving aid from the skin. Shaving debris (not shown) must be periodically cleaned from the razor 202 to prevent clogging of a blade 208, or a plurality of blades. The shaving debris can include removed hair and the shaving aid. Alternatively, the razor 202 can be used in a dry shaving process whereby the hair is removed from the skin with the razor 202 while the skin is dry. Even when dry, the shaving debris must be periodically cleaned from the razor 202 to prevent clogging of the blade 208, or the plurality of blades.

The razor 202 is a ubiquitous device used for removing hair from the skin and is commercially available in various configurations. FIGS. 1-3 depict an example of an embodiment of a cartridge-type razor 202. The cartridge-type razor 202 generally comprises a handle 204 configured to accept an exchangeable cartridge 206. The exchangeable cartridge 206 includes at least one blade 208. The blade 208 further comprises at least one cutting edge 210 configured to remove the hair from the skin. The cutting edge 210 is typically not configured to be serviced by a user. Instead, the exchangeable cartridge 206 is replaced when the cutting edge 210 becomes dull from use, or the exchangeable cartridge 206 no longer performs effectively.

The exchangeable cartridge 206 is configured to be separated from the handle 204 at an interface 214. A used exchangeable cartridge 206 can therefore be detached from the handle 204 at the interface 214, discarded, and a new exchangeable cartridge 206 can be installed onto the handle 204. In FIGS. 1-3, the razor 202 is shown with a plurality of blades 208, each blade 208 having the cutting edge 210.

While not exhaustive, other example embodiments of the razor 202 are a straight razor, a safety razor, and a fully disposable razor. The straight razor typically comprises scales (i.e. for holding) and a pivoting straight blade with a cutting edge that is often configured to be maintained by the user. An additional example of the razor 202 is the safety razor. The safety razor commonly comprises a hand grip and a guide assembly configured to accept a replaceable blade. A used replaceable blade is exchanged for a new replaceable blade when a cutting edge, or a plurality of cutting edges, dulls or the blade is no longer performing adequately. The fully disposable razor is intended to be replaced when any aspect of the device becomes unsatisfactory. Fully disposable razors often comprise a single blade and a cutting edge or a plurality of blades and cutting edges.

Razors 202 generally include at least one cleaning zone 212. The cleaning zone 212 is configured to provide access to the cutting edge 210 of the blade 208 so the shaving debris can be removed periodically. During the shaving process, a rinsing fluid, for example water, is directed at the cleaning zone 212 to cause hydraulic agitation and remove the shaving debris from the cutting edge 210 of the blade 208. An example of the cleaning zone 212 is shown in FIGS. 1-3 for an embodiment of the cartridge-type razor 202. The razor rinser device 10 shown in FIGS. 1-11 is configured for use with the cartridge-type razor 202. As will be described in below, however, the razor rinser device 10 is fully adaptable and can be configured for use with alternative configurations of the razor 202.

The razor rinser device 10 includes a basin 12, a pump 14, a contact surface 116, and at least one discharge section 16. The basin 12 is a vessel configured to contain the rinsing fluid (not shown) at a first pressure. The pump 14 is in fluid communication with the basin 12. The pump 14 is configured to increase the first pressure of the rinsing fluid to a second pressure. The contact surface 116 is configured to interface with at least one surface 216 of the razor 202. The discharge section 16 is in fluid communication with the pump 14 and configured to direct the rinsing fluid toward the blade 208 of the razor 202. The contact surface is configured to form a seal with the at least one surface 216 of the razor 202 and maintain a fluid path between the discharge section 116 and at the at least one blade 208 of the razor. Additionally, or alternatively, the rinsing fluid can be directed toward the cleaning zone 212 of the razor 202. As shown in the embodiment of FIGS. 1-11, the pump 14 can be disposed concentrically within the basin 12. The discharge section 16 can be arranged concentrically with the pump 14. In this configuration, the components of the razor rinser device 10 are aligned with a common centerline axis. In alternative embodiments, the components are disposed in other suitable arrangements.

Referring to FIGS. 1-11, the basin 12 is configured as an open vessel with a volumetric capacity 18 that is sufficient to contain a suitable amount of the rinsing fluid. In the embodiment shown, the first pressure of the rinsing fluid is therefore ambient pressure. The shape of the basin 12, can be any suitable geometry configured to contain the rinsing fluid and accommodate the various features and components of the razor rinser device 10. In the embodiment depicted in the figures, the shape of the basin 12 results in a volume of the rinsing fluid that resembles a toroid. In other alternative embodiments, the basin 12 can cause the volume of the rinsing fluid to have other suitable shapes. In other alternative embodiments, the basin 12 can be configured as an enclosed volume. In embodiments with the enclosed volume, the basin can be configured to maintain the rinsing fluid at the first pressure other than ambient.

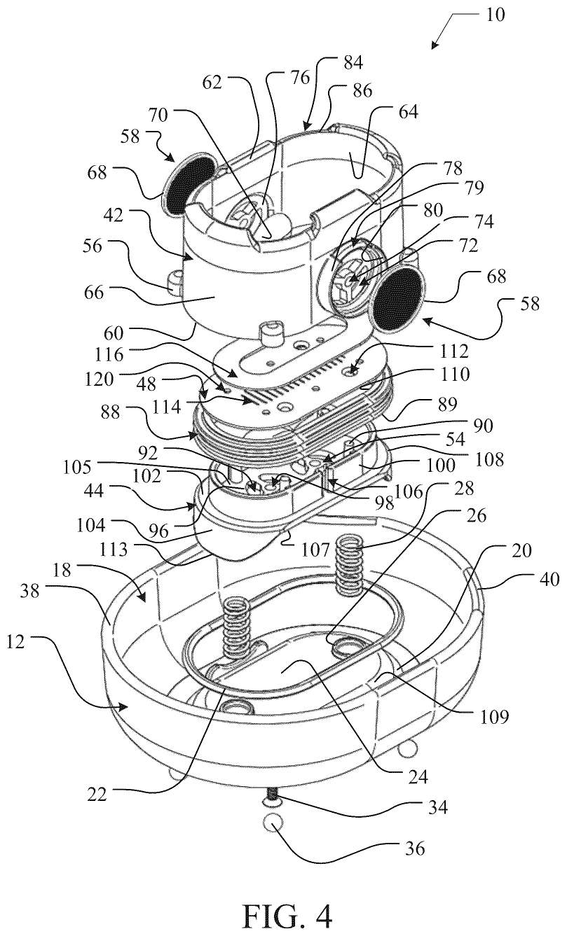

The basin 12 includes mounting provisions for other components of the razor rinser device 10. For example, as shown in FIG. 4, the basin 12 includes an interior surface 20 that is configured to receive at least one gasket 22 and at least one spring 28. The gasket 22 is described in greater detail below. The basin 12 further includes an interior proximal surface 24. The interior proximal surface 24 can include at least one indexing element 26. The indexing element 26 can be configured, for example, to index the spring 28. The springs 28 are discussed in greater detail below.

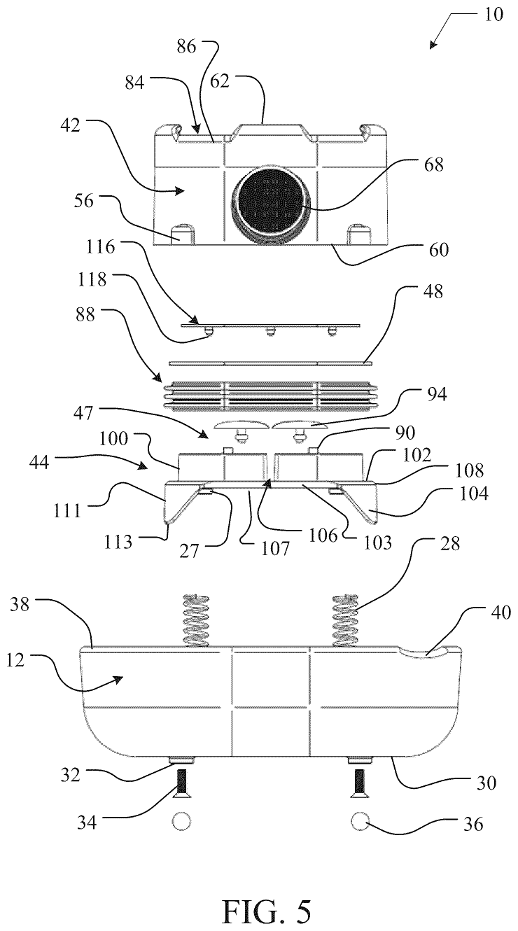

As shown in FIG. 5, the basin 12 includes an exterior distal surface 30. At least one pedestal 32 can be included at the exterior distal surface 30 of the basin 12. The pedestal 32 can be configured to elevate and/or stabilize the basin 12. The pedestal 32 can further be configured to accept hardware 34. For example, the pedestal 32 can include at least one concentric hole configured to accept hardware 34. The hardware 34 can pass through the pedestal 32 and the basin 12 to mount other components of the razor rinser device 10. As depicted in the embodiment of FIG. 5., a plurality of pedestals 32 can be provided, and the hardware 34 can be a mechanical fastener or a plurality of mechanical fasteners. Additionally, or alternatively, the pedestals 32 can be configured to accept at least one foot 36 or a corresponding plurality of feet 36. The feet 36 can be configured to provide a sufficient seal at the pedestals 32 such that the rinsing fluid does not leak. The feet 36 can be used in conjunction with, or in the absence of, the hardware 34. The feet 36 can be made of a material with a sufficiently high coefficient of friction to mitigate the tendency of the basin 12 to slip on a surface (not shown). For example, the feet 36 may be made of a polymer, a rubber, an elastomer material, or any other suitable material.

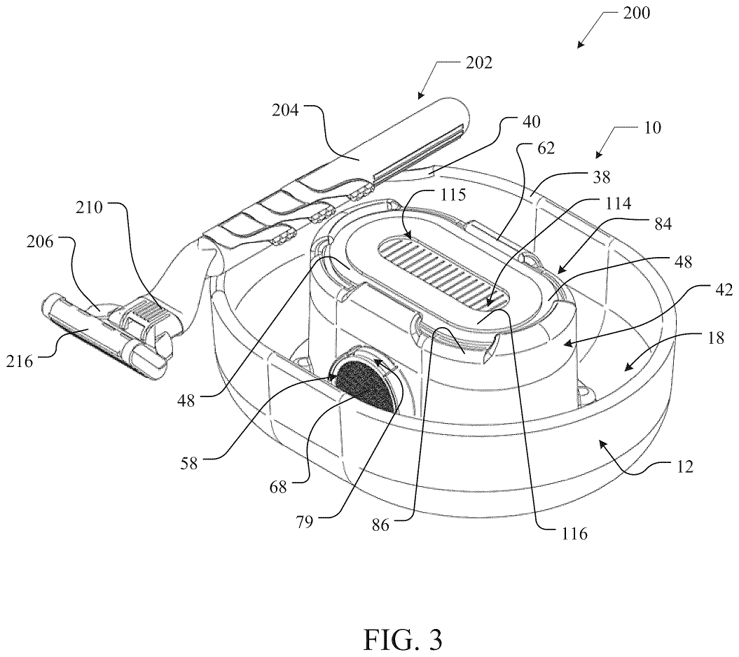

Referring to FIG. 3, the basin can include at least one receptacle 40 configured to maintain the razor 202 in a resting position. The receptacle 40 serves as a substantially stable location to store the razor 202. When not in use, the handle 204 of the razor 202 can be disposed within the receptacles 40 such that a portion of an outer surface of the handle 204 contacts a proximal surface of the receptacle 40. As shown, a proximal edge 38 defines an apex of the basin 12. The embodiment depicted, for example, includes two receptacles 40 configured to receive the handle 204 of the razor 202. The receptacles 40 are depicted in FIG. 3 as two recesses, or notches, in the proximal edge 38 of the basin 12. The receptacles 40 are positioned at substantially similar elevations. Therefore, as shown, the resting position can be a substantially horizontal orientation, with the handle 204 contacting the two edges of the receptacles 40. The razor 202 can be conveniently stored in the receptacles 40 on the basin 12 and in a substantially stationary orientation. In other alternative embodiments, the receptacles 40 can maintain the razor 202 at an orientation other than horizontal. Additionally, the receptacles 40 can be an integral feature of any component, or combination of components, of the razor rinser device 10. In alternative embodiments, the receptacle 40 can be a separate component that is mounted to the razor rinser device 10.

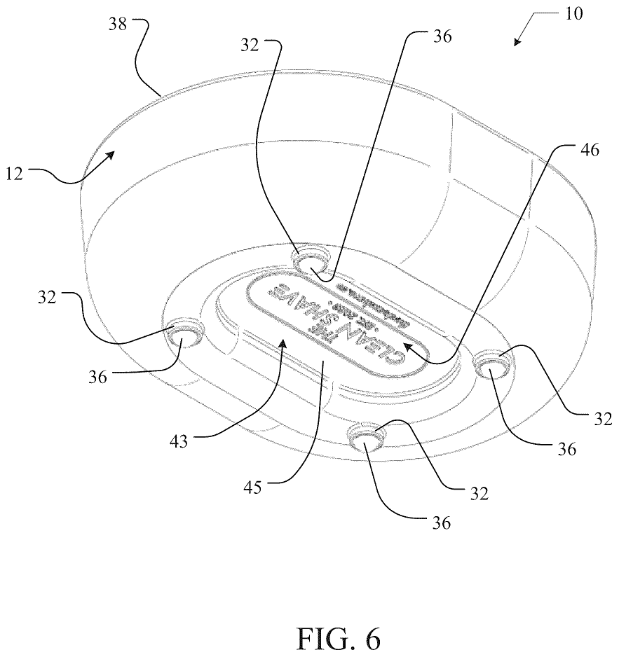

Referring to FIG. 6, the basin 12 can include a recess 43 configured to define a recessed distal surface 45. The recessed distal surface 45 can provide a suitable area to information, for example product information 46. The information 46 can include branding, company details, instructions, warnings, etc. As shown in FIG. 6, for example, the information 46 includes, “THE CLEAN SHAVE CO. EST. 2023” and further provides, “thecleanshave.co” website address. In other alternative embodiments, the recessed distal surface 45 can be used for other suitable purposes.

The basin 12 can made from a polymer material suitable for injection molding or mechanical forming. In alternative embodiments, the basin 12 can be made of stainless steel or another suitable metallic material. Additionally, or alternatively the basin 12 can comprise two or more materials. The basin 12 or any component of the razor rinser device 10, can further be made to be opaque, translucent, or optically transparent.

Referring again to FIGS. 1-11, the pump 14 can be configured as a piston pump. The piston pump is configured to increase the first pressure of the rinsing fluid. The piston pump can further be configured as a positive displacement pump. The piston pump includes a housing 42, a movable piston 44, at least one fluid outlet 54, and a spray manifold 48. The housing 42 is in fluid communication with the basin 12. The movable piston 44 is disposed within the housing 42 and configured to define at least one fluid chamber 50. The fluid outlet 54 is in fluid communication with the fluid chamber 50. In the embodiment shown in the figures, the movable piston 44 is configured to define the fluid outlet 54. As shown in the figures, the piston pump can further be configured to include at least one additional fluid chamber 52. In embodiments that include the additional fluid chamber 52, the additional fluid chamber 52 is in fluid communication with the fluid outlet 54. Additionally, or alternatively, the at least one fluid chamber 50 can be configured as a first fluid chamber and the at least one additional fluid chamber 52 can be configured as a second fluid chamber. The spray manifold 48 is in fluid communication with the fluid outlet 54 and is an example embodiment of the discharge section 16. The spray manifold 48 is therefore configured to direct the rinsing fluid toward at the blade 208 of the razor 202. Additionally, or alternatively, the spray manifold 48 can direct rinsing fluid toward the cleaning zone 212 of the razor 202.

In other alternative embodiments, the pump 14 can be another suitable pump. For example, a centrifugal pump, a gear pump, an axial pump, a plunger pump, or any other suitable pump. As shown is FIGS. 1-11, the preferred embodiment of the pump 14 is manually powered. In alternative embodiments, the pump 14 can be electrically or electronically powered. For example, the pump can be battery-powered or powered by line voltage.

As shown in FIGS. 1-11, the housing 42 includes the gasket 22, mounting provisions 56, and at least one fluid inlet 58. The housing 42 further includes a distal surface 60, a proximal surface 62 configured to define an apex of the housing 42, an inner surface 64, and an outer surface 66. In the embodiment shown, the housing 42 is disposed concentrically within the basin 12. The housing 42 is further configured to mount to the basin 12 and form a fluid-tight seal.

For example, the gasket 22 can be installed between the interior surface 20 of the basin 12 and the distal surface 60 of the housing 42. As shown in FIGS. 4 and 5, the hardware 34 is inserted through the pedestals 32 on the basin 12. The mounting provisions 56 of the housing 42 are configured to receive, and interface with, the hardware 34. When installed, the hardware 34, for example the mechanical fasteners, is configured to provide sufficient pressure to compress the gasket 22 between the interior surface 20 of the basin 12 and the distal surface 60 of the housing 42 to form a suitable the fluid-tight seal. The hardware 34 further secures the housing 42 to the basin 12. As previously discussed, the feet 36 can be inserted into the pedestals 32 to form the fluid-tight seal at the exterior distal surface 30 of the basin 12.

In alternative embodiments, other methods may be used to mount the housing 42 to the basin 12 and form the fluid-tight seal. For example, adhesives and/or sealants may be used in addition to, or in place of, the gasket 22 and/or the feet 36. Additionally, or alternatively, the housing 42 and the basin 12 can be configured with integral mounting provisions. For example, the housing 42 and basin 12 can be configured with mechanical mating surfaces that deform or interlock when sufficient force is applied, for example a “snap-fit.” In other alternative embodiments, the housing 42 and the basin 12 can be welded together in a chemical or heating process. In other embodiments, the housing 42 and the basin 12 can be formed as one piece.

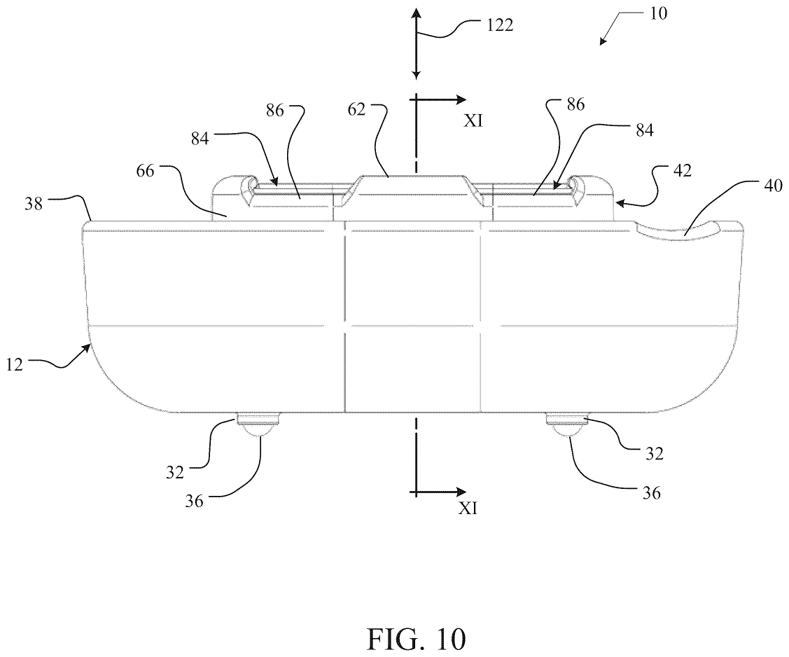

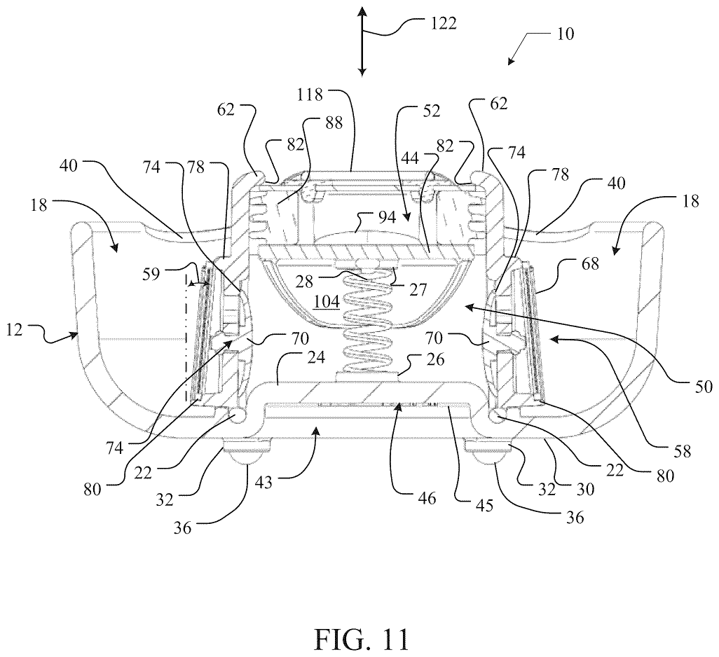

As shown in the embodiment of FIGS. 1-11, the housing 42 includes two fluid inlets 58 in fluid communication with the basin 12 and configured to direct the rinsing fluid into the housing 42. The fluid inlets 58 are positioned at an elevation on the housing 42. Referring to FIGS. 4 and 11, the fluid inlets 58 are configured to define a fluid path 72 between the basin 12 and the housing 42. The fluid inlets 58 are further configured to accept at least one inlet valve 70 and further include a corresponding valve seating surface 76. As shown in FIG. 4, the fluid path 72 is positioned within the fluid inlet 58 and can be a plurality of openings between the inner surface 64 and the outer surface 66 of the housing 42. A valve mounting provision 74 within the fluid inlet 58 accepts the inlet valve 70. In the embodiment shown in FIG. 11, the inlet valve 70 is configured to be press fit into the valve mounting provision 74. Once installed, the inlet valve 70 remains in place. The valve seating surface 76 allows the inlet valve 70 to seal the fluid path 72 when in a closed position. As shown in FIGS. 4 and 11, the valve seating surface 76 is formed as an integral component of the inner surface 64 of the housing 42. The inlet valve 70 is therefore installed within the housing 42. In the embodiment shown in FIGS. 10-11, the inlet valves 70 are shown as umbrella valves. The umbrella valve is a one-way valve that permits fluid to flow in only one direction. In other alternative embodiments, the inlet valve 70 can be any other suitable style of valve that permits fluid to flow in one direction. The valve mounting provision 74 can similarly be any suitable mounting technique configured to retain the inlet valves 70 in a desired location. The fluid path 72 can be any suitable pathway that permits fluid to flow between the basin 12 and the housing 42.

As shown in FIGS. 1-11, the fluid inlet 58 further includes an integral embossment 78 configured to accept at least one inlet filter 68. The embossment 78 protrudes from the outer surface 66 of the housing 42 and further includes at least one filter mount 80 and at least one recess 79. The inlet filter 68 is configured to fit within the filter mount 80. The filter mounts 80 are configured to allow removal and installation of the inlet filters 68. As shown in FIG. 11, the embossments 78 can be configured to dispose the filter mounts 80 at an angle 59 relative to a vertical axis. Preferrable, the angle 59 is not zero degrees. The recess 79 is configured to allow access to an outer surface of the inlet filter 68. As shown in the figures, the recess 79 can be a region of the embossment 78 that does not protrude from the housing 42. Alternatively, the recess 79 can be a region of the embossment 78 that does not protrude from the housing 42 to the same extent as the other regions of the embossment 78. The angle 59 of the filter mounts 80 and the recess 79 facilitate access to remove and reinstall the inlet filters 68. The angle 59 can be any angle suitable to accomplish this purpose.

The inlet filters 68 are further configured to be removable. As shown in the figures, the inlet filters 68 can be configured to be press fit into the filter mounts 80. For example, the inlet filters 68 can be slightly larger than the filter mount 80, resulting in an interference. When the inlet filter 68 is pressed into the filter mount 80, the interference between the outer surface of the inlet filter 68 and an inner surface of the filter mount 80 causes at least one retention force to develop. The retention force is sufficient to retain the inlet filter 68 within the filter mount 80. In alternative embodiments, the filter mount 80 and inlet filter 68 can include interfacing threads to allow for threaded removal and re-installation of the inlet filters 68.

As shown in the figures, the inlet filter 68 is provided at each fluid inlet 58. The inlet filters 68 are configured to prevent particulates (not shown) of a certain size from entering the fluid inlet 58. When using the razor rinser device 10, particulates in the form of the shaving debris are created during the shaving process and accumulates in the basin. The inlet filters 68 prevent the shaving debris from entering the pump 14 and causing a clog or damage. As shown in FIGS. 1-11, the inlet filters 68 can be mesh screens. The inlet filters 68 are preferably made of stainless steel. In alternative embodiments, the inlet filters 68 can be made of plastic, a composite, or any other suitable material configured to withstand the rinsing fluid and routine cleaning. In other alternative embodiments, the inlet filters 68 can be disposable. In disposable embodiments, the inlet filters 68 can be made of biodegradable material or any material suitable for an intended service life.

Referring to FIGS. 1-11, the proximal surface 62 of the housing 42 defines an apex of the housing 42. Preferably, the apex of the housing 42 is configured to have an elevation exceeding an elevation of the proximal edge 38 defining the apex of the basin 12. In alternative embodiments, the apex of the housing 42 is not taller than the apex of the basin 12. In other alternative embodiments, the apex of the housing 42 is taller than a liquid height of the rinsing fluid.

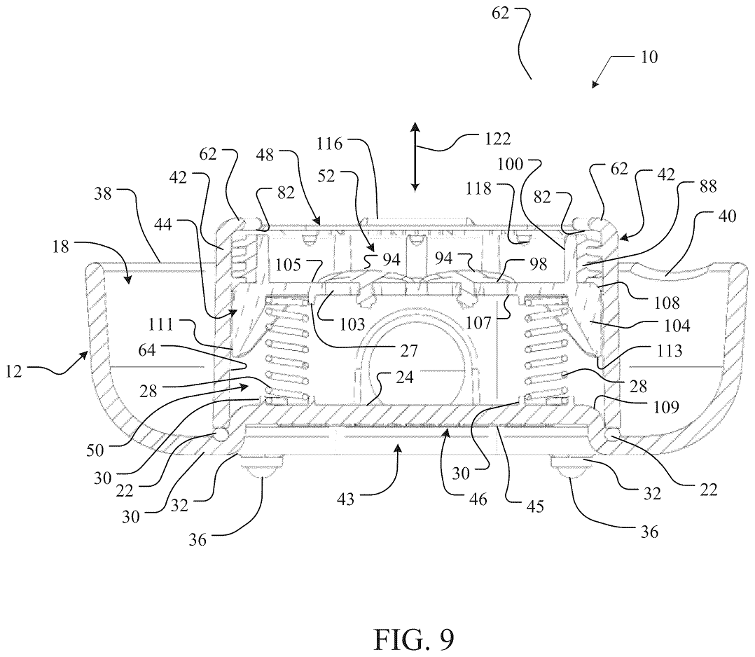

The proximal surface 62 includes a retaining surface 82 configured to retain the discharge section 16. In the embodiment shown in FIGS. 1-11, for example, the discharge section 16 is provided as the spray manifold 48, mounted to the movable piston 44. As shown in FIGS. 9-11, the retaining surface 82 can be an integral feature of the housing 42. As shown, an edge of the housing is turned inwardly over a defined region. Within the defined region, the outer surface 66 is the proximal surface 62 and the inner surface 64 is the retaining surface 82. The retaining surface 82 creates an abrupt reduction in an inner dimension of the housing 42. The reduced dimension of the housing 42 prevents the spray manifold 48 and the movable piston 44 from traveling longitudinally past the retaining surface 82. In the embodiment shown in the figures, the retaining surface 82 is integral to the housing 42. In other embodiments, the retaining surface 82 can be a separate component, for example, a ring or any suitable device configured to retain the spray manifold 48 and movable piston 44.

The proximal surface 62 of the housing 42 can further include at least one drain 84. The drain 84 is configured to allow a fluid, for example the rinsing fluid, to drain to the basin 12. Referring FIGS. 1, 3-5, 8 and 10, the drain 84 can be a plurality of drains. The drains 84 can be configured as an integral recess 86 in the proximal surface 62. The recess 86 reduces the elevation of the proximal surface 62 to an extent below the spray manifold 48 so that the rinsing fluid is less likely to pool or become trapped. In the embodiment shown, the retaining surface 82 is not provided in the region where the drain 84 is located. In other embodiments, the recess 86 can be provided without the drain 84. In other alternative embodiments, the retaining surface 82 can be provided where there is a drain 84.

The housing 42 can made from a polymer material or any other materials suitable for injection molding or mechanical forming. The housing 42 can further be made to be opaque, translucent, or optically transparent. In alternative embodiments, the housing 42 can be made of stainless steel or another suitable metallic material. Additionally, or alternatively, the housing 42 can comprise two or more materials.

Referring to FIGS. 1-11, the movable piston 44 includes a transverse member 103 having a proximal surface 105 and a distal surface 107, at least one sealing device 88, and at least one fluid outlet 54. The movable piston 44 can further include at least one wall 100, at least one ledge 102, at least one seal notch 106, at least one guide 104, at least one indexing element 27, and manifold mounting provisions 90. Additionally, the movable piston 44 can include the at least one additional fluid chamber 52. The fluid outlet 54 is in fluid communication with the fluid chamber 50. In the embodiment shown in the figures, the at least one fluid chamber 50 can be configured as a first fluid chamber and the at least one additional fluid chamber 52 can be configured as a second fluid chamber. In alternative embodiments, the at least one additional fluid chamber 52 can be provided as a plurality of additional fluid chambers. Additionally, or alternatively, the fluid outlet 54 can be configured to be in fluid communication the additional fluid chamber 52. In alternative embodiments that do not include the additional fluid chamber 52, the fluid outlet 54 can be configured as the spray manifold 48. Additionally, or alternatively, the discharge section 16 can be the spray manifold 48.

Referring to FIGS. 4 and 9, the movable piston 44 includes two fluid outlets 54. The fluid outlets 54 are positioned on the transverse member 103 of the movable piston 44. The fluid outlets 54 are configured to define at least one fluid path 92 between the fluid chamber 50 and the additional fluid chamber 52. The fluid outlets 54 are further configured to accept at least one outlet valve 94 and include a corresponding valve seating surface 96. The proximal surface 105 of the transverse member 103 can be configured as the valve seating surface 96. As shown in FIG. 4, the fluid path 92 is positioned within the fluid outlet 54 and can be at least one opening in the transverse member 103, configured to permit fluid to flow through the transverse member 103. At least one valve mounting provision 98 within the fluid outlet 54 accepts the outlet valve 94. In the embodiment shown in FIG. 9, the outlet valve 94 is configured to be press fit into the valve mounting provision 98. Once installed, the outlet valve 94 remains in place.

The valve seating surface 96 allows the outlet valve 94 to seal the fluid path 92 when in a closed position. As shown in FIGS. 4 and 9, the valve seating surface 96 is formed as an integral component of the movable piston 44. The outlet valve 94 is therefore installed within the additional fluid chamber 52. In the embodiment shown in FIGS. 4 and 9, the outlet valve 94 is shown as an umbrella valve. As discussed, the umbrella valve is a one-way valve that permits fluid to flow in only one direction. In other alternative embodiments, the outlet valve 94 can be any other suitable style of valve that permits fluid to flow in one direction. The valve mounting provision 98 can similarly be any suitable mounting technique configured to retain the outlet valve 94 in a desired location. The fluid path 92 can be any suitable pathway that permits fluid to flow from the fluid chamber 50 to the additional fluid chamber 52. In alternative embodiments, the additional fluid chamber 52 is not included. In such embodiments, the fluid path 92 can be any suitable pathway that permits fluid to flow from the fluid chamber 50 to the discharge section 16, for example the spray manifold 48.

Referring to FIGS. 4-5, 9 and 11, the wall 100 extends from the proximal surface 105 of the transverse member 103 and is configured to provide lateral structural support for the sealing device 88. As shown, the wall 100 is inwardly offset from an outer edge 108 of the transverse member 103 to define the ledge 102. The inward direction is towards a concentric vertical axis, positioned at the center of the transverse member 103. The outer edge 108 of the transverse member 103 is configured to define at least one periphery of the movable piston 44. The ledge 102 can comprise a portion of the proximal surface 105 of the transverse member 103. The ledge 102 is configured to provide vertical structural support for the sealing device 88. The wall 100 can define the at least one seal notch 106. The seal notch 106 is configured to interface with a projection (not shown) on the sealing device 88. In embodiments that include the additional fluid chamber 52, the wall 100 can be configured to define at least one dimension of the additional fluid chamber 52. In alternative embodiments, the wall 100 can be omitted.

The sealing device 88 is configured to maintain a fluid-tight seal between the inner surface 64 of the housing 42 and the outer edge 108 of the transverse member 103. The sealing device 88 is arranged concentrically with the movable piston 44. An inner surface 110 of the sealing device 88 is configured to fit against an exterior surface of the wall 100. A distal surface 89 of the sealing device 88 is configured to fit against the ledge 102. The projection (not shown) interfaces with the seal notch 106. The sealing device 88 is retained on the movable piston 44 in a substantially fixed position by the interface of the inner surface 110 with the wall 100 and the distal surface 89 with the ledge 102. The seal notch 106 indexes the sealing device 88 and further limits relative motion between the movable piston 44 and the sealing device 88. The protrusion of the sealing device 88 can be configured to form an interference with the seal notch 106. The interference between an outer surface of the protrusion on the sealing device 88 and an inner surface of the seal notch 106 causes at least one retention force to develop. The retention force further retains the sealing device 88 against the wall 100, thereby mitigating separation between the inner surface 110 of the sealing device 88 and the wall 100. In other embodiments, the sealing device can be mounted to the movable piston 44 using other suitable methods configured to limit relative motion between the movable piston 44 and the sealing device 88. For example, the sealing device 88 can be glued, adhered, mechanically fastened, interference fit, or made to be an integral feature of the movable piston.

As shown in FIGS. 4-5, 9 and 11, the sealing device 88 is configured as a triple seal gasket. Additionally, or alternatively, the sealing device 88 can be a scraper gasket. The sealing device 88 is further configured to minimize friction between sealing device 88 and the inner surface 64 of the housing. Minimizing friction is desirable because it reduces the amount of energy required to actuate the movable piston 44 and reduces wear on the sealing device 88. Suitable materials for the sealing device 88 include elastomers, plastics, nylon, polymer, and any other material having a substantially low coefficient of friction and capable of forming a fluid-tight seal while in motion.

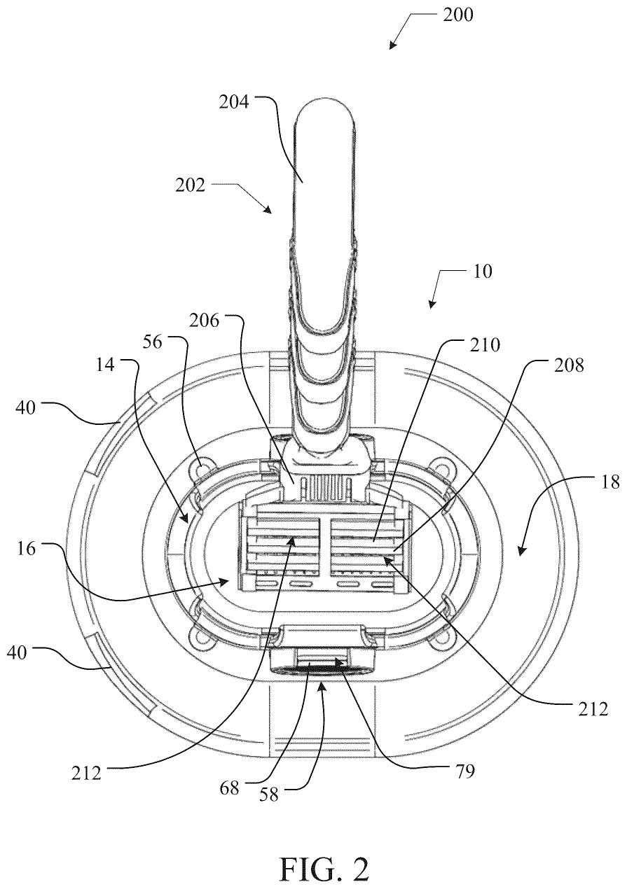

Referring to FIGS. 2, 4, and 9, the piston can include at least one guide 104. The guides 104 can further include at least one distal surface 113. In the embodiment shown, the guides 104 protrude distally (i.e. away) from the distal surface 107 of the transverse member 103. The distal surface 113 of the guide 104 is configured to interface with at least one inner mating surface 109 of the basin 12. The extent of protrusion of the distal surface 113 of the guide 104 from the distal surface 107 of the transverse member 103 defines the minimum volume of the fluid chamber 50. At least one outer surface 111 of the guide 104 is configured to interface with the inner surface 64 of the housing 42. Preferably, the movable piston 44 is configured to maintain an interface between the outer surface 111 of the guide 104 and the inner surface 64 of the housing 42 such that the movable piston 44 is free to travel axially within the housing 42, while remaining substantially aligned. The movable piston 44 is aligned, for example, when a piston centerline is coincident with a vertical centerline of the housing 42, and the transverse member 103 is in a substantially horizontal orientation. In alternative embodiments, the outer edge 108 of the transverse member 103 can be configured as the guides 104. In other alternative embodiments, the minimum volume of the fluid chamber 50 can be defined by protrusions on the inner mating surface 109 of the basin 12 or an inner surface of the fluid chamber 50.

The distal surface 107 can include at least one indexing element 27. The indexing element 27 can be configured, for example, to index the at least one spring 28. In the embodiment shown, indexing elements 26 on the basin 12 and indexing elements 27 on the distal surface 107 of transverse member 103 are provided in corresponding pairs and are configured to maintain the springs 28 in a substantially aligned orientation. Further, indexing elements 26, 27 are configured to be substantially concentric. As shown, the springs 28 are configured as helical compression springs. Preferably, the springs 28 are configured to develop a preload when installed. A proximal end of the spring 28 is arranged concentrically within the indexing element 27 on the transverse member 103 and a distal end of the spring 28 is arranged concentrically with the indexing element 26 on the basin 12. A proximal surface of the spring 28 is in contact with the distal surface 107 of the transverse member 103 and a distal surface of the spring is in contact with the interior proximal surface 24 of the basin 12. In alternative embodiments, other suitable types of springs may be used in lieu of helical compression springs.

The manifold mounting provisions 90 are configured to mount the spray manifold 48 to the movable piston 44. As shown in FIG. 4, the manifold mounting provisions 90 are configured to retain the spray manifold 48 at a proximal end of the movable piston 44. In the embodiment shown, the elevation of the walls 100 define the proximal end of the movable piston 44. The manifold mounting provisions 90 can be cylindrical protrusions of sufficient length to dispose the spray manifold 48 at the proximal position. The spray manifold 48 includes corresponding mounting provisions 112. The manifold mounting provisions 90 and corresponding mounting provisions 112 can be configured for securement in a heat stake process. For example, the corresponding mounting provisions 112 can be through holes configured to receive the manifold mounting provisions 90, provided as cylindrical protrusions. The cylindrical protrusions can be configured to extend beyond a proximal surface of the spray manifold 48 by a distance suitable for the heat stake process. Further, the cylindrical protrusions can be made of a material that deforms when heated. In the heat stake process, the distance of the cylindrical protrusions extending beyond the proximal surface of the spray manifold 48 is heated and a regional deformation of the cylindrical protrusion occurs. The regional deformation secures the spray manifold 48 to the movable piston 44. The regional deformation can be flush with the proximal surface of the spray manifold 48.

In alternative embodiments, the manifold mounting provisions 90 can be configured to receive hardware (not shown), for example, mechanical fasteners. The corresponding mounting provisions 112 can be through holes configured to receive hardware. The corresponding mounting provisions 112 can further be configured to maintain the hardware flush with the proximal surface of the spray manifold 48. For example, the corresponding mounting provisions 112 can include a countersink. The spray manifold 48 can therefore be mounted to the movable piston 44 using manifold mounting provisions 90 and corresponding mounting provisions 112. In other alternative embodiments, suitable methods of mounting include fastening with mechanical fasteners, riveting, gluing, adhering, and welding.

The movable piston 44 can made from a polymer any suitable material for injection molding or mechanical forming. The piston can further be made to be opaque, translucent, or optically transparent. In alternative embodiments, the movable piston can be made of stainless steel or another suitable metallic material. Additionally, or alternatively the movable piston 44 can comprise two or more materials.

The spray manifold 48 is configured to accelerate the rinsing fluid. In the embodiment shown in FIGS. 1-11, the spray manifold 48 is in fluid communication with the additional fluid chamber 52. The spray manifold 48 includes at least one jet 114 configured to accelerate the rinsing fluid. As shown, the spray manifold includes a plurality of jets 114. The jets 114 can be slots defining a fluid passageway from a distal surface to the proximal surface of the spray manifold 48. The pump 14, for example, the piston pump, causes an increase in the first pressure of the rinsing fluid. The jets 114 are configured to convert the increase in pressure to an increase in velocity as the rinsing fluid is discharged to the ambient. The jets 114 are further configured to direct the rinsing fluid toward the blade 208 of the razor 202. Additionally, or alternatively, the rinsing fluid can be directed toward the cleaning zone 212 of the razor 202. The spray manifold is preferably be made of stainless steel. In alternative embodiments, the spray manifold 48 can be made of plastic, a composite, or any other suitable material configured to withstand the rinsing fluid and routine use.

In alternative embodiments that do not include the at least one additional fluid chamber 52, the fluid outlet 54 of the movable piston 44 can be configured as the spray manifold 48. For example, the fluid path 92 can be configured as the plurality of jets 114. Additionally, or alternatively, the transverse member 103 can be configured as the spray manifold 48. In this example, the spray manifold 48 is in fluid communication with the fluid chamber 50. Further, outlet valves 94, valve mounting provisions 98, and valve seating surface 96 can be located in another suitable location such that pressure relationships are maintained. In other alternative embodiments, the additional fluid chamber 52 is included but the outlet valves 94, valve mounting provisions 98, and valve seating surface 96 are located in a suitable alternative location such that the pressure relationships are maintained.

Referring to FIG. 4, the spray manifold 48 includes the contact surface 116. The contact surface 116 is configured to interface with the at least one surface 216 of the razor 202. The surface 216 defines the extents of the cleaning zone 212 or plurality of cleaning zones, and/or the blade 208 or plurality of blades. The contact surface 116 is configured to receive the surface 216 of the razor 202. The contact surface 116 is further configured to stabilize the razor 202 while using the razor rinser device 10. Additionally, or alternatively, the contact surface 116 can be configured increase coefficient of friction between the at least one surface 216 of the razor 202 and the contact surface 116 to minimize relative motion, for example slipping.

The contact surface 116 is configured to form a seal between the surface 216 of the razor 202 and the spray manifold 48 while maintaining a fluid path 115 between the discharge section 16 and the blade 208 of the razor 202. As shown in FIGS. 1-3, the fluid path 115 permits the rinsing fluid to be directed to the cleaning zone 212 or plurality of cleaning zones, and/or the blade 208 or plurality of blades while the surface 216 of the razor pressed against the contact surface 116. Forming the seal minimizes leakage of the rinsing fluid and therefore maximizes the volume of rinsing fluid that is directed at the blade 208, or the cleaning zone 212, of the razor 202. Maximizing the volume of rinsing fluid directed at the blade 208, or the cleaning zone 212, is desirable because it increases the degree of hydraulic agitation available to remove the shaving debris.

The shape of the contact surface 116 can be adapted to fit the at least one surface 216 of various configurations of the razor 202. As shown in FIGS. 1-11, the contact surface 116 is configured to fit the surface 216 of an exchangeable cartridge 206. As discussed, the embodiment shown of the razor rinser device 10 is configured for use with a cartridge-type razor 202. The contact surface 116 can be adapted and configured to stabilize and seal many known configurations of the razor 202. In alternative embodiments, the contact surface 116 can be configured for use with the razor 202 in the fully disposable razor configuration. In other alternative embodiments, the contact surface 116 is configured for use with the razor 202 in the safety razor configuration. In other alternative embodiments, the contact surface is configured for use with the razor 202 configured as a straight razor.

As shown in FIG. 5, the contact surface includes tabs 118 that are configured to mount to corresponding receivers 120 in the spray manifold 48. The receivers 120 are configured as holes between the proximal surface and the distal surface of the spray manifold 48. As shown in FIGS. 5, 9 and 11, the tabs 118 are configured to press through the receivers 120 and mechanically interlock when a sufficient length of tab 118 has been inserted into the receiver 120. The contact surface 116 is maintained in a substantially stationary position in relation to the spray manifold 48. In alternative embodiments, other suitable methods of mounting the contact surface 116 may be used. For example, the contact surface 116 may be glued, adhered, mechanically fastened. heat staked, welded, or any suitable method to retain the contact surface 116. In other alternative embodiments, the contact surface 116 can be an integral part of the spray manifold 48. The contact surface 116 is preferably made of a material with a high coefficient of friction and the ability to form a fluid-tight seal. For example, the contact surface 116 may be made of an elastomer, a polymer, a rubber, or a composite. Metallic or plastic materials are also suitable.

Referring to FIGS. 1-11, the movable piston 44, outlet valves 94, sealing device 88, spray manifold 48, and contact surface 116 can be assembled into a piston assembly. For example, the outlet valves 94 can be installed into the valve mounting provisions 98 and seal against the corresponding valve seating surfaces 96 of the transverse member 103. The sealing device 88 can be assembled to the movable piston 44 in the manner previously described. The spray manifold 48 can be installed to the movable piston 44 via the manifold mounting provisions 90 and corresponding mounting provisions 112. The contact surface 116 can be installed to the spray manifold 48 via the tabs 118 and receivers 120. The housing 42, the inlet valves 70, the inlet filters 68, and the gasket 22 can be similarly assembled into a housing assembly. For example, the inlet valves 70 can be installed into the valve mounting provisions 74 and seal against the corresponding valve seating surfaces 76 of the housing 42. The inlet filters 68 can be installed into the filter mounts 80 of the embossments 78.

As discussed, the movable piston 44 is configured to maintain an interface between the outer surface 111 of the guide 104, and the inner surface 64 of the housing 42. Similarly, the sealing device 88 is configured to form a suitable seal between the outer edge 108 of the movable piston 44 and the housing 42. The arrangement is such that the movable piston 44 is free to travel axially within the housing 42, while remaining substantially aligned and a fluid-tight seal at the outer edge 108 of the transverse member 103 is maintained. The movable piston 44 is aligned, for example, when its vertical centerline is coincident with a vertical centerline of the housing 42, and the transverse member 103 is in a substantially horizontal position. When aligned, a proximal end of the movable piston assembly can be inserted into a distal end of the housing assembly. The piston assembly can be further inserted into the housing assembly until the proximal end contacts the retaining surface 82. The proximal end of the springs 28 can be installed into the indexing elements 27. The assembled piston assembly and housing assembly form a piston pump assembly.

The piston pump assembly, the gasket 22, the hardware 34, the feet 36, and the basin 12 can be assembled to form the razor rinser device 10. For example, the gasket 22 can be installed on the interior surface 20 of the basin 12. The piston pump assembly can be aligned concentrically with the basin 12. Additionally, or alternatively, the mounting provisions 56 of the housing 42 can be aligned with the pedestals 32 of basin 12. The distal ends of the springs 28 can be installed into the indexing elements 26. The distal surface 60 of the housing can be installed on a proximal surface of the gasket 22. The hardware 34 can be inserted through the pedestals 32 on the basin 12 and interfaced with the mounting provisions 56 of the housing 42. The hardware 34 can be tightened to compress the gasket 22 to form the suitable fluid-tight seal between the interior surface 20 of the basin 12 and the distal surface 60 of the housing 42. The feet 36 can be inserted into the pedestals 32 to form the fluid-tight seal at the exterior distal surface 30 of the basin 12. The resulting assembly is configured for use as the razor rinser device 10. Alternative suitable methods of assembly will be readily apparent to one having skilled in the art. For other alternative embodiments of the razor rinser device 10, other suitable assembly methods can be readily prescribed.

Referring to FIGS. 1-3 and 9, 11, the springs 28 are configured to bias the piston assembly in a first position. The piston assembly is at the first position when the proximal end of the piston assembly contacts the retaining surface 82 of the housing assembly. Further, in the first position, the piston assembly is at a maximum elevation within the housing assembly. The springs 28 are not substantially compressed. As discussed, however, the springs 28 can be preloaded. The piston assembly is movable in an axial direction within the housing 42 between the first position and a second position. Arrow 122 depicts the axial direction in FIGS. 1 and 8-11. The piston assembly is at the second position when the distal surface 113 of the guide 104 contacts the inner mating surface 109 of the basin 12. Further, in the second position, the piston assembly is at a minimum elevation within the housing assembly. The springs 28 are substantially compressed and exert a restorative force on the piston assembly. The restorative force tends to return the piston assembly from the second position to the first position.

Referring to the embodiment of FIGS. 9 and 11, the fluid chamber 50 has a variable volume and the additional fluid chamber 52 has a constant volume. A volume of the fluid chamber 50 is defined by the interior proximal surface 24 of the basin 12, the inner surface 64 of the housing 42, and the distal surface 107 of the transverse member 103. As the piston assembly travels from the first position to the second position, the volume of the fluid chamber 50 decreases. Similarly, as the piston assembly travels from the second position to the first position, the volume the fluid chamber 50 increases.

A volume of the additional fluid chamber 52 is defined by the proximal surface 105 of the transverse member 103, the wall 100 of the movable piston 44, and the distal surface of the spray manifold 48. As the piston assembly travels from the first position to the second position, the volume of the additional fluid chamber 52 remains constant. Similarly, as the piston assembly travels from the second position to the first position, the volume the additional fluid chamber 52 remains constant. In alternative embodiments that include the additional fluid chamber 52, either the fluid chamber 50 or the at least one additional fluid chamber 52 can have a variable volume. In other alternative embodiments that include the at least one additional fluid chamber 52, both the fluid chamber 50, or the at least one additional fluid chamber 52 can have a variable volume.

Referring to FIGS. 1-3, a razor rinser system 200 can include the razor rinser device 10, the rinsing fluid, and the razor 202. The razor rinser system 200 is configured to remove shaving debris from the razor 202. FIGS. 1-3 depict an example of an embodiment of a cartridge-type razor 202. The embodiment of the razor rinser system 200 shown is configured for use with the cartridge-type razor 202. The razor 202, however, is a ubiquitous device used for removing hair from the skin and is commercially available in various configurations. As previously described, the razor rinser device 10 can be configured for use with virtually any configuration of the razor 202. For example, suitable embodiments of the razor 202 can include a razor 202 that is configured for use with a replacement blade 208, for example the safety razor. Other suitable embodiments of the razor 202 include the disposable razor. Still other suitable embodiments of the razor 202 include a razor with a fixed blade 208, such as the straight razor. The rinsing fluid can be water or any other suitable fluid. For example, the rinsing fluid can be a mixture of water and a cleaning agent, for example, isopropyl alcohol.

Referring to the embodiment shown in FIGS. 1-11, the razor rinser system 200 is configured to operate as a manual, positive displacement, piston pump. The basin 12 can be filled with a fluid, for example, the rinsing fluid. The rinsing fluid can be maintained at a first pressure, for example, ambient pressure. Preferably, a sufficient amount of the rinsing fluid is added to the volumetric capacity 18 of the basin 12, such that the liquid level line exceeds the fluid inlets 58. After the rinsing fluid is added to the basin, additional rinsing fluid is not usually required. The surface 216 of the razor 202 can then be interfaced with the contact surface 116 of the spray manifold 48 to align the at least one blade 208 or the at least one cleaning zone 212 with the jets 114. At this stage, the inlet valves 70 are sealed against valve seating surfaces 76 and the outlet valves 94 are sealed against valve seating surfaces 96.

A rinsing cycle begins when the user imparts a downward force directed through the handle 204 of the razor 202, to the contact surface 116, and in the axial direction, depicted in FIGS. 1, 8-11 by the arrow 122. The force can be sufficient to overcome the force, or preload, of the springs 28. If sufficient force is applied, the piston assembly moves axially from the first position toward the second position. As the piston assembly moves, the variable volume of the fluid chamber 50 reduces. At this stage, the inlet valves 70 remain closed, and the outlet valves 94 are similarly closed. A fixed quantity of the rinsing fluid is contained within the fluid chamber 50 and fluids, such as the rinsing fluid, are generally incompressible. The volume of an incompressible fluid remains constant under pressure. As the variable volume of the fluid chamber 50 reduces, forces develop within the fixed quantity of the rinsing fluid. The forces cause the first pressure of the rinsing fluid to increase toward a second pressure. As the piston assembly is depressed further toward the second position the forces increase, and the first pressure continues to increase toward the second pressure.

When the rinsing fluid reaches the second pressure, the outlet valves 94 unseat from the valve seating surfaces 96. When the outlet valves 94 unseat, fluid communication is established between fluid chamber 50 and the additional fluid chamber 52. Rinsing fluid flows through the fluid paths 92 of the fluid outlets 54 from the distal surface 107 to the proximal surface 105 of the transverse member 103 and into the additional fluid chamber 52. As the piston assembly is depressed towards the second position the constant volume of the additional fluid chamber 52 fills with the rinsing fluid.

As the piston assembly is depressed further towards the second position the variable volume of the fluid chamber 50 continues toward the minimum volume and the constant volume of the additional fluid chamber 52 remains fixed. With the outlet valves 94 open and fluid communication established through the fluid outlets 54, pressure in the additional fluid chamber 52 increases. The additional fluid chamber 52, however, is open to the ambient via the jets 114 of the spray manifold 48. The rinsing fluid follows a path of least resistance and is expelled through the jets 114 to the ambient, which is at ambient pressure. The jets 114 are configured to convert a potential energy of the rinsing fluid in the form of the second pressure to a kinetic energy in the form of a velocity. The conversion of energy results in a plurality of accelerated streams of the rinsing fluid to discharge from the spray manifold 48. The spray manifold 48 is further configured to direct the accelerated streams of the rinsing fluid toward at least one blade 208 or at least one cleaning zone 212 of the razor. The accelerated streams of the rinsing fluid provide the hydraulic agitation to remove the shaving debris from the razor 202.

The piston assembly is depressed until the distal surfaces 113 of the guides 104 interface with the at least one inner mating surface 109 of the basin 12, and the piston assembly is in the second position. The accelerated streams of the rinsing fluid continue to flow from the jets 114 of the spray manifold 48 and remove the shaving debris until the piston reaches the second position. The shaving debris is deflected off of the at least one blade 208 or flows through the at least one cleaning zone 212 of the razor 202. The rinsing fluid and shaving debris are returned to the basin 12 through the drains 84 in the proximal surface 62 of the housing 42. The rinsing cycle is thus complete.

When the piston assembly is in the second position, the fluid chamber 50 is at the minimum volume and the springs 28 are compressed. The pressure of the rinsing fluid remaining within the fluid chamber 50 is sufficiently reduced, for example to ambient pressure. The outlet valves 94 reseat against the valve seating surfaces 96 and are closed. At this stage, the inlet valves 70 similarly are closed A filling cycle begins when the springs 28 impart the restorative force that causes the piston assembly to tend to travel from the second position toward the first position. As the movable piston advances toward the second position, the user can impart a resistive force directed through the handle 204 of the razor 202, to the contact surface 116, and in opposite the axial direction to control the piston assembly.

As the piston assembly advances toward the second position, the variable volume of the fluid chamber 50 increases and the volume of the additional fluid chamber 52 remains fixed. A fixed remaining quantity of the rinsing fluid is contained within the fluid chamber 50. Again, the volume of an incompressible fluid remains constant under pressure. As the variable volume of the fluid chamber 50 increases, opposite forces develop within the fixed remaining quantity of the rinsing fluid. The opposite forces cause the first pressure of the rinsing fluid to decrease from a remaining pressure toward a suction pressure. The pressure of the rinsing fluid remaining in the at least one fluid chamber 50 therefore decreases to the suction pressure as the movable piston 44 moves from the second position to the first position.

When the rinsing fluid reaches the suction pressure, the inlet valves 70 unseat from the valve seating surfaces 96. When the inlet valves 70 unseat, fluid communication is established between basin 12 and the additional fluid chamber 52. Rinsing fluid flows from the basin 12 through the fluid inlet 58. The inlet filters 68 trap the shaving debris and permit only the rinsing fluid to flow. The rinsing fluid continues through the fluid paths 72 of the fluid inlets 58 and into the fluid chamber 50. As the piston assembly is further restored from the second position to the first position, the variable volume of the fluid chamber 50 fills with the rinsing fluid. The outlet valves 94 remain closed while the fluid chamber 50 fills with the rinsing fluid.

When piston assembly is returned to the first position, the variable volume of the fluid chamber 50 is filled with rinsing fluid. The pressure of the rinsing fluid is again at the first pressure, for example ambient pressure. At this stage, the inlet valves 70 are sealed against valve seating surfaces 76 and the outlet valves 94 are sealed against valve seating surfaces. The filling cycle is thus complete.

The rinsing cycle and the filling cycle are alternated in sequence until the shaving debris has been sufficiently removed from the razor 202 or when the shaving process is completed. The shaving process includes removing the hair from the skin with the razor 202. When the shaving process completes, the rinsing fluid and the shaving debris can be emptied from the basin 12. For example, the basin 12 can be emptied into a water closet, the environment, a holding tank, etc. An active drain is not required. The inlet filters 68 can be removed from the filter mounts 80 and cleaned. Once cleaned, the inlet filters 68 can be reinstalled in the filter mounts 80. In alternative embodiments, the inlet filters 68 can be disposed of and replaced.

A priming cycle can be initiated if the fluid chamber 50 of the razor rinser device 10 contains air. The fluid chamber 50 could contain air, for example if it a first use, the razor rinser device 10 has been emptied, or the inlet valves 70 and/or outlet valves 94 are failing. The priming cycle is virtually identically to the rinsing cycle. The primary distinction is that the priming cycle expels air from the spray manifold 48 but the rinsing cycle expels the rinsing fluid from the spray manifold 48. All other steps in the sequence remain the same.

Referring to razor rinser system 200 shown in FIGS. 1-11, the volumetric capacity 18 of the basin 12 has is fixed and only the sufficient amount of the rinsing fluid is needed. Further, the rinsing cycle and the filling cycle recirculate the sufficient amount of the rinsing fluid. Additionally, the piston pump is provided as a mechanical device that is actuated by the user. The razor rinser system 200 shown can be configured to be self-contained.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above-described embodiments. Rather, the scope of the present solution should be defined in accordance with the following claims and their equivalents.

Further, the present disclosure is not to be limited in terms of the particular examples described in this application, which are intended as illustrations of various aspects. Many modifications and examples can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and examples are intended to fall within the scope of the appended claims. The present disclosure is to be limited only by the terms of the appended claims, along with the full scope of equivalents to which such claims are entitled. It is also to be understood that the terminology used herein is for describing particular examples only and is not intended to be limiting.

What is claimed is:

1. A razor rinser device, comprising:
a basin configured to contain a rinsing fluid at a first pressure;
a pump in fluid communication with the basin and configured to increase the pressure of the rinsing fluid to a second pressure;
a contact surface configured to interface with a surface of a razor; and
a discharge section in fluid communication with the pump and configured to direct the rinsing fluid toward a blade of the razor.

2. The razor rinser device of claim 1, wherein the basin comprises a receptacle configured to receive a handle of the razor and maintain the razor in a resting position.

3. The razor rinser device of claim 1, wherein the basin comprises a recessed area configured to display information.

4. The razor rinser device of claim 1, wherein the basin comprises at least one pedestal configured to stabilize the basin.

5. The razor rinser device of claim 1, wherein the basin comprises an indexing element disposed on an interior proximal surface of the basin, the indexing element configured to retain a spring.

6. The razor rinser device of claim 1, wherein:
the pump is concentrically disposed within the basin and
the discharge section is arranged concentrically with the pump.

7. The razor rinser device of claim 1, wherein the discharge section comprises a spray manifold configured to accelerate the rinsing fluid.

8. The razor rinser device of claim 1, wherein the contact surface is configured to stabilize the razor.

9. The razor rinser device of claim 1, wherein the contact surface is configured to form a seal with the surface of the razor and maintain a fluid path between the discharge section and the blade of the razor.

10. The razor rinser device of claim 1, wherein the pump is a positive displacement pump.

11. The razor rinser device of claim 1, wherein the pump is a piston pump, comprising:
a housing in fluid communication with the basin;
a movable piston disposed within the housing and configured to define a fluid chamber; and
wherein the pump defines a fluid outlet in fluid communication with the fluid chamber.

12. The razor rinser device of claim 11, wherein:
the housing is configured to mount to the basin; and
the housing further comprises:
a proximal surface configured to define an apex of the housing;
a fluid inlet configured to direct the rinsing fluid into the housing; and
an inlet valve in fluid communication with the fluid inlet.

13. The razor rinser device of claim 12, wherein the proximal surface further comprises a drain configured to allow the rinsing fluid to flow to the basin.

14. The razor rinser device of claim 12, wherein the proximal surface further includes a retaining surface configured to retain the movable piston within the housing.

15. The razor rinser device of claim 12, wherein the fluid inlet comprises an embossment configured to define a filter mount.

16. The razor rinser device of claim 15, wherein the embossment is configured to orient the filter mount at an angle other than zero degrees with respect to a vertical axis.

17. The razor rinser device of claim 15, wherein the filter mount is configured to receive an inlet filter.

18. The razor rinser device of claim 17, wherein the filter mount is configured to facilitate removal of the inlet filter therefrom.

19. The razor riser device of claim 12, wherein the inlet valve is configured to permit the rinsing fluid to flow in only one direction.

20. The razor riser device of claim 19, wherein the inlet valve is an umbrella valve.

21. The razor rinser device of claim 11, wherein the movable piston comprises:
an outlet valve in fluid communication with the fluid outlet, and
a sealing device configured to form a seal between a periphery of the movable piston and an inner surface of the housing.

22. The razor riser device of claim 21, wherein the outlet valve is configured to permit the rinsing fluid to flow in only one direction.

23. The razor riser device of claim 21, wherein the outlet valve is an umbrella valve.

24. The razor rinser device of claim 21, wherein the movable piston further comprises a transverse member configured to fit within the housing, the transverse member comprising:
an outer edge configured to define the periphery of the movable piston;
a proximal surface; and
a distal surface.

25. The razor rinser device of claim 24, wherein the transverse member further comprises a guide, the guide comprising:
a distal surface configured to interface with an inner mating surface of the basin; and
an outer surface configured to interface with the inner surface of the housing.

26. The razor rinser device of claim 25, wherein the distal surface of the guide extends away from the distal surface of the transverse member.

27. The razor rinser device of claim 24, wherein the transverse member further comprises an indexing element disposed on the distal surface of the transverse member and configured to retain a spring.

28. The razor rinser device of claim 24, wherein:
the fluid chamber is a first fluid chamber; and
the transverse member further comprises a wall extending proximally from the proximal surface of the transverse member and configured to define a second fluid chamber in fluid communication with the at least one fluid outlet.

29. The razor rinser device of claim 28, wherein the wall is offset inwardly from the outer edge of the transverse member and defines a ledge.

30. The razor rinser device of claim 28, wherein the wall defines a seal notch configured to interface with at least one protrusion on the sealing device.

31. The razor rinser device of claim 28, wherein the fluid outlet comprises a spray manifold in fluid communication with the second fluid chamber, wherein the spray manifold is configured to accelerate the rinsing fluid.

32. The razor rinser device of claim 31, further comprising a contact surface configured to interface with the surface of the razor, wherein the contact surface is configured to form a seal with the surface of the razor and maintain a fluid path between the spray manifold and the blade of the razor.

33. The razor rinser device of claim 11, wherein a volume of the fluid chamber is variable.

34. The razor rinser device of claim 28, wherein a volume of the additional chamber is constant.

35. The razor rinser device of claim 28, wherein the movable piston is configured to travel axially from a first position to a second position.

36. The razor rinser device of claim 35, wherein:
the first position corresponds to a minimum volume of the fluid chamber; and
the second position corresponds to a maximum volume of the additional fluid chamber.

37. The razor rinser of claim 35, wherein the piston pump further comprises a spring configured to bias the movable piston toward the first position.

38. The razor rinser device of claim 37, wherein the spring is positioned between an interior proximal surface of the basin and a distal surface of the movable piston.

39. The razor rinser of claim 37, wherein the spring is a helical compression spring.

40. The razor rinser device of claim 36, wherein the movable piston is configured to increase the pressure of the rinsing fluid from the first pressure as the movable piston moves from the first position to the second position.

41. The razor rinser device of claim 40, wherein:
the first pressure is ambient pressure; and
the second pressure is sufficient to open the outlet valve.

42. The razor rinser device of claim 41, wherein the rinsing fluid flows from the outlet valve after reaching the second pressure.

43. The razor rinser device of claim 36, wherein the movable piston is configured to decrease a pressure of the rinsing fluid remaining in the first fluid chamber to a suction pressure as the movable piston travels from the second position to the first position.

44. The razor rinser device of claim 43, wherein the suction pressure is sufficient to open the inlet valve.

45. The razor rinser device of claim 44, wherein the rinsing fluid flows through fluid inlet after reaching the suction pressure.

46. The razor rinser device of claim 21, wherein the sealing device is a triple seal gasket configured to reduce friction between the periphery of the movable piston and an inner surface of the housing.

47. A razor rinser system; comprising:
the razor rinser device of claim 1;
a rinsing fluid; and
a razor configured for shaving hair.

48. The razor rinser system of claim 47, wherein the razor is a cartridge-type razor.

49. The razor rinser system of claim 47, wherein the razor is a disposable razor.

50. The razor rinser system of claim 47, wherein the razor is a safety razor.

51. The razor rinser system of claim 47, wherein the rinsing fluid is water.

52. The razor rinser system of claim 47, wherein the rinsing fluid is a mixture of water and a cleaning agent.

53. A method for cleaning a razor, comprising:
preparing a razor rinser device, comprising:
a basin configured to contain a rinsing fluid at a first pressure;
a pump in fluid communication with the basin and configured to increase the pressure of the rinsing fluid to a second pressure;
a contact surface configured to interface with a surface of a razor and
a discharge section in fluid communication with the pump and configured to direct the rinsing fluid toward at least one blade of the razor;
shaving hair with a razor; and
rinsing shaving debris from the razor using the razor rinsing device.

54. The method of claim 53, wherein preparing the razor rinser device comprises filling the basin with a sufficient amount of the rinsing fluid.

55. The method of claim 53, further comprising priming the pump.

56. The method of claim 53, further comprising repeating the shaving and rinsing steps until a shaving process is complete.

57. The method of claim 53, further comprising emptying the basin.

58. The method of claim 53, further comprising removing an inlet filter from a filter mount.

59. The method of claim 58, further comprising removing shaving debris from the inlet filter.

60. The method of claim 58, further comprising installing the inlet filter within the filter mount.
